(19) United States
(12) Patent Application Publication
(10) Pub. No.: US 2019/0053607 A1
(43) Pub. Date: Feb. 21, 2019

(54) ELECTRONIC APPARATUS AND METHOD FOR PROVIDING MAKEUP TRIAL INFORMATION THEREOF

(71) Applicant: CAL-COMP BIG DATA, INC., New Taipei City (TW)

(72) Inventors: Shyh-Yong Shen, New Taipei City (TW); Min-Chang Chi, New Taipei City (TW); Yuan-Shan Chien, New Taipei City (TW); Ching-Wei Wang, New Taipei City (TW)

(73) Assignee: CAL-COMP BIG DATA, INC., NEW TAIPEI CITY (TW)

(21) Appl. No.: 15/871,126

(22) Filed: Jan. 15, 2018

(30) Foreign Application Priority Data
Aug. 16, 2017 (CN) 201710700422.3

(51) Int. Cl. A45D 44/00; G06F 3/0484; G06K 9/00

(52) U.S. Cl. CPC A45D 44/005; G06F 3/04845; G06F 3/04817; G06F 3/04842; G06K 9/00255

(57) ABSTRACT

The invention provides a method for makeup trial information adapted for an electronic apparatus having a display. The display displays a facial image of a person trying makeup before or after editing. The method includes steps as follows: displaying a makeup trial part selecting frame through the display; displaying a makeup trial type selecting frame through the display in response to receiving a first operation corresponding to the makeup trial part selecting frame; editing the facial image in response to receiving a second operation corresponding to the makeup trial type selecting frame; and displaying a makeup trial result frame through the display, and recording an editing sequence and an edited parameter of the facial image, wherein the makeup trial result frame includes the facial image after editing. In addition, an electronic apparatus is also provided. The invention provides quick, accurate, and convenient makeup trial information and functions.

### CROSS-REFERENCE TO RELATED APPLICATION

This application claims the priority benefit of China application serial no. 201710700422.3, filed on Aug. 16, 2017. The entirety of the above-mentioned patent application is hereby incorporated by reference herein and made a part of this specification.

### BACKGROUND OF THE INVENTION

### 1. Field of the Invention

The invention relates to a makeup trial simulation technology, and particularly relates to an electronic apparatus and a method for providing makeup trial information of the electronic apparatus.

### 2. Description of Related Art

Wearing makeup is one way of beauty treatment, and is considered as part of the manners in some occasions. Besides, wearing makeup helps one look more confident, and is even adopted as a means of healthcare. Thus, more and more cosmetic products and techniques are developed. Due to the diversity of cosmetic products and techniques, one needs to try multiple cosmetic products and techniques in order to choose the most suitable makeup.

However, conventional makeup trials require people to try repetitively to have a sense of effects rendered by different cosmetic products. In other words, one must spend a long time and money for different cosmetic products to find out a desirable makeup. Nevertheless, the effects of the respective makeup trials are unable to be compared effectively and accurately. Thus, how to quickly, accurately, and conveniently provide makeup trial information becomes an issue to work on.

### SUMMARY OF THE INVENTION

The invention provides an electronic apparatus and a method for providing makeup trial information of the electronic apparatus capable of quickly, accurately, and conveniently providing makeup trial information and functions.

A method for makeup trial information according to an embodiment of the invention is adapted for an electronic apparatus having a display. The display displays a facial image of a person trying makeup before or after editing. The method for makeup trial information includes the following: displaying a makeup trial part selecting frame through the display, wherein the makeup trial part selecting frame comprises the facial image; displaying a makeup trial type selecting frame through the display in response to receiving a first operation corresponding to the makeup trial part selecting frame; editing the facial image in response to receiving a second operation corresponding to the makeup trial type selecting frame; and displaying a makeup trial result frame through the display, and recording an editing sequence and an edited parameter of the facial image, wherein the makeup trial result frame includes the facial image after editing.

According to an embodiment of the invention, the electronic apparatus further includes an image capturing device, and the method for makeup trial information further includes obtaining the facial image through the image capturing device.

According to an embodiment of the invention, the electronic apparatus further includes a storage device, and the method for makeup trial information further includes accessing the storage device to obtain the facial image.

According to an embodiment, editing the facial image in response to receiving the second operation corresponding to the makeup trial type selecting frame includes: displaying a makeup trial sub-type selecting frame through the display in response to receiving the second operation corresponding to the makeup trial type selecting frame; and editing the facial image in response to receiving a third operation corresponding to the makeup trial sub-type selecting frame.

According to an embodiment of the invention, editing the facial image in response to receiving the third operation corresponding to the makeup trial sub-type selecting frame includes: displaying a makeup trial adjustment frame through the display in response to receiving the third operation corresponding to the makeup trial sub-type selecting frame; and adjusting a makeup trial result of the facial image in the makeup trial result frame in response to receiving a fourth operation corresponding to the makeup trial adjustment frame.

According to an embodiment of the invention, the method for makeup trial information further includes storing the facial image after editing based on whether a fifth operation corresponding to the makeup trial result frame is received.

According to an embodiment of the invention, the method for makeup trial information further includes sequentially editing the facial image and sequentially displaying a plurality of the facial images after editing in the makeup trial result frame through the display in response to a plurality of the first operations and a plurality of the second operations.

According to an embodiment of the invention, the method for makeup trial information further includes dynamically restoring to one of the facial images after editing according to the editing sequence and the edited parameter in response to a sixth operation based on whether the sixth operation corresponding to the makeup trial result frame is received.

An electronic apparatus according to an embodiment of the invention includes a display and a processor. The display displays a facial image of a person trying makeup before or after editing. The processor is coupled to the display. The processor displays a makeup trial part selecting frame through the display, wherein the makeup trial part selecting frame comprises the facial image. The processor displays a makeup trial type selecting frame through the display in response to receiving a first operation corresponding to the makeup trial part selecting frame. The processor edits the facial image in response to receiving a second operation corresponding to the makeup trial type selecting frame. The processor displays a makeup trial result frame through the display, and records an editing sequence and an edited parameter of the facial image. The makeup trial result frame includes the facial image after editing.

According to an embodiment of the invention, the electronic apparatus further includes an image capturing device, and the processor obtains the facial image through the image capturing device.

According to an embodiment of the invention, the electronic apparatus further includes a storage device, and the processor obtains the facial image by accessing the storage device.

According to an embodiment of the invention, in the electronic apparatus, the processor displays a makeup trial sub-type selecting frame through the display in response to receiving the second operation corresponding to the makeup trial type selecting frame, and the processor edits the facial image in response to receiving a third operation corresponding to the makeup trial sub-type selecting frame.

According to an embodiment of the invention, in the electronic apparatus, the processor displays a makeup trial adjustment frame through the display in response to receiving the third operation corresponding to the makeup trial sub-type selecting frame, and the processor adjusts a makeup trial result of the facial image in the makeup trial result frame in response to receiving a fourth operation corresponding to the makeup trial adjustment frame.

According to an embodiment of the invention, the processor stores the facial image after editing based on whether a fifth operation corresponding to the makeup trial result frame is received.

According to an embodiment of the invention, in the electronic apparatus, the processor sequentially edits the facial image and sequentially displays a plurality of the facial images after editing in the makeup trial result frame through the display in response to a plurality of the first operations and a plurality of the second operations.

According to an embodiment of the invention, the processor dynamically restores to one of the facial images after editing according to the editing sequence and the edited parameter in response to a sixth operation based on whether the sixth operation corresponding to the makeup trial result frame is received.

Based on the above, the electronic apparatus and the method for makeup trial information of the electronic apparatus according to the embodiments of the invention enable different makeup trials through operation of the person trying makeup in the makeup trial part selecting frame and the makeup trial type selecting frame. Accordingly, the facial image of the person trying makeup is edited by the processor of the electronic apparatus. Accordingly, the person trying makeup is provided with quick, accurate, and convenient makeup trial results through the display of the electronic apparatus.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a view illustrating an electronic apparatus according to an embodiment of the invention.

FIG. 2 is a flowchart illustrating a method for providing makeup trial information according to an embodiment of the invention.

FIG. 3 is a detailed flowchart illustrating a method for providing makeup trial information according to an embodiment of the invention.

FIG. 4 is a schematic view illustrating an analysis on a facial image according to the invention.

FIG. 5A is a schematic view illustrating a makeup trial part selecting frame according to an embodiment of the invention.

FIG. 5B is a schematic view illustrating a makeup trial type selecting frame according to an embodiment of the invention.

FIG. 5C is a schematic view illustrating a makeup trial sub-type selecting frame according to an embodiment of the invention.

FIG. 5D is a schematic view illustrating a makeup trial adjustment frame according to an embodiment of the invention.

FIG. 6 is a schematic view illustrating a plurality of makeup trial operations according to an embodiment of the invention.

FIG. 7 is a schematic view illustrating a makeup trial result frame according to an embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

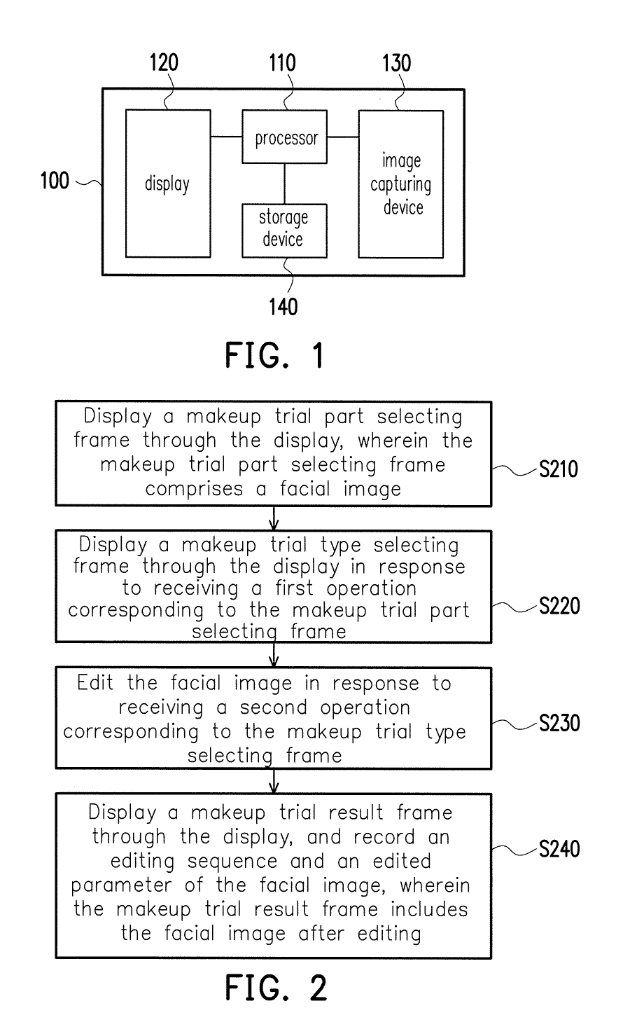

FIG. 1 is a view illustrating an electronic apparatus according to an embodiment of the invention. Referring to FIG. 1, an electronic apparatus 100 includes a processor 110, a display 120, an image capturing device 130, and a storage device 140. The processor 110 is coupled to the display 120, the image capturing device 130, and the storage device 140. The processor 110 is configured to drive the display. In the embodiment, the electronic apparatus 100 may be an apparatus disposed on a dressing table. The display 120 of the electronic apparatus 100 may be disposed behind a mirror, and text or images displayed on the display 120 may be viewable for a person trying makeup through the mirror. In other embodiments, the electronic apparatus 100 may also be consumer electronics, such as a smartphone, a tablet computer, or the like. Alternatively, the electronic apparatus 100 may also be a portable mirror box combined with a portable mirror.

In the embodiment, the processor 110 may be, for example, a central processing unit (CPU), a programmable general-purpose or specific-purpose microprocessor, a digital signal processor (DSP), a programmable controller, an application specific integrated circuit (ASIC), a programmable logic device (PLD), other similar processing devices, or a combination thereof.

In the embodiment, the display 120 may be disposed in a display area of the electronic apparatus 100 and is a display device providing a display function. The display 120 may be a display screen device providing a display function, such as a liquid crystal display (LCD), a light emitting diode (LED) display, a field emission display (FED), or the like. In the embodiment, the screen 120 is configured to display a facial image of the person trying makeup before or after editing. In the embodiment, the image capturing device 130 may be a camera or a video camera, and is configured to capture an image so as to obtain a current facial image of the person trying makeup. In addition, the facial image includes image data.

In the embodiment, the storage device 140 may be an arbitrary type of fixed or portable random access memory (RAM), read-only memory (ROM), flash memory, other similar devices, or a combination thereof. In addition, the storage device is configured to record a plurality of commands executable by the processor 110. The commands may be loaded into the processor 110. The storage device 140 may also store the facial image of the person trying makeup in advance. In addition, various steps compatible with a method for providing makeup trial information according to the respective embodiments of the invention may be implemented through chip hardware or firmware in the electronic apparatus 100, and may also be implemented through software or application programs stored in the storage device 140 and executed by the processor 110 in the electronic apparatus 100.

In addition, in the invention, the display 120 may be a touch display and is adopted to input data and choose an icon. Alternatively, an external input device (not shown), such as a mouse, a keyboard, a joystick, or a touch pad may be adopted to input data and choose an icon. Moreover, the data may be input and the icon may be chosen by using the image capturing device 130 to identify a gesture or even through sound control. It should be noted that the invention does not intend to impose a limitation on this regard.

FIG. 2 is a flowchart illustrating a method for providing makeup trial information according to an embodiment of the invention. Referring to FIGS. 1 and 2, the method for providing makeup trial information of the embodiment is at least suitable for the electronic apparatus 100 of FIG. 1. In addition, the display 120 of the electronic apparatus 100 is adapted to display the facial image of the person trying makeup before or after editing. At Step S210, the processor 110 displays a makeup trial part selecting frame through the display 120. In addition, the makeup trial part selecting frame includes the facial image. At Step S220, in response to receiving a first operation corresponding to the makeup trial part selecting frame, the processor 110 displays a makeup trial type selecting frame through the display. At Step S230, in response to receiving a second operation corresponding to the makeup trial type selecting frame, the processor 110 edits the facial image. At Step S240, the processor 110 displays a makeup trial result frame through the display, and records an editing sequence and an edited parameter of the facial image. In addition, the makeup trial result frame includes the facial image after editing.

In order for people having ordinary skill in the art to better understand the electronic apparatus and the method for providing makeup trial information of the invention, several embodiments are provided in the following to describe in greater detail.

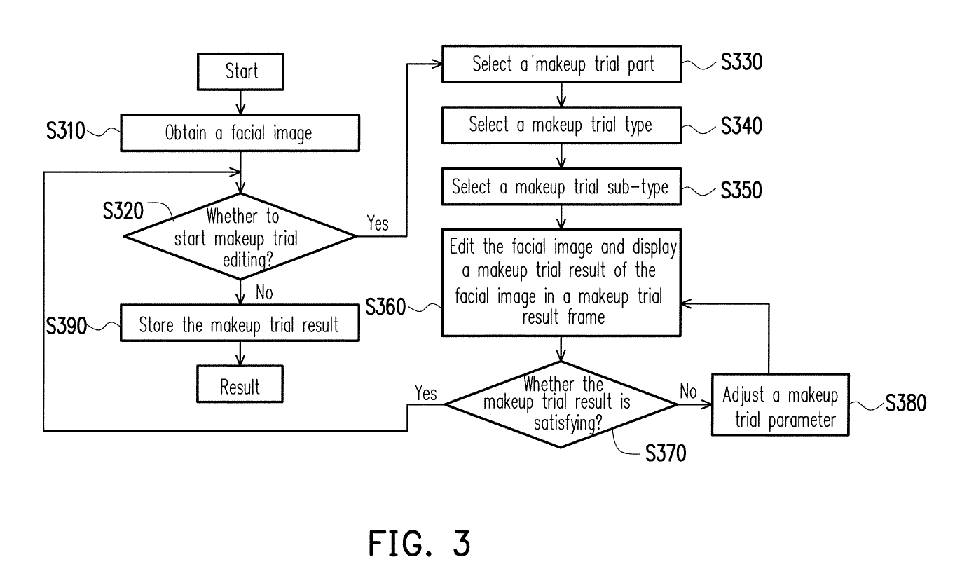

FIG. 3 is a detailed flowchart illustrating a method for providing makeup trial information according to an embodiment of the invention. Referring to FIGS. 1 and 3, the method for providing makeup trial information is at least suitable for the electronic apparatus 100 of FIG. 1. First of all, at Step S310, the processor 110 may obtain the facial image through the image capturing device 130 of the electronic apparatus 100. However, the invention is not limited thereto. In an embodiment, the processor 110 may also access the storage device 140 of the electronic apparatus 100 to obtain a facial image stored in advance. Then, at Step S310, the person trying makeup chooses whether to carry out makeup trial editing. If the person trying makeup chooses to carry out makeup trial editing, the processor 110 analyzes the facial image and performs a relevant image editing procedure.

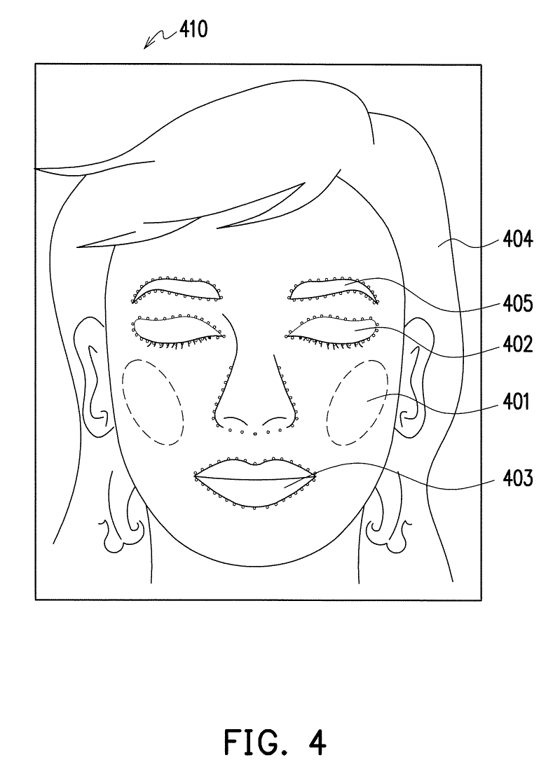

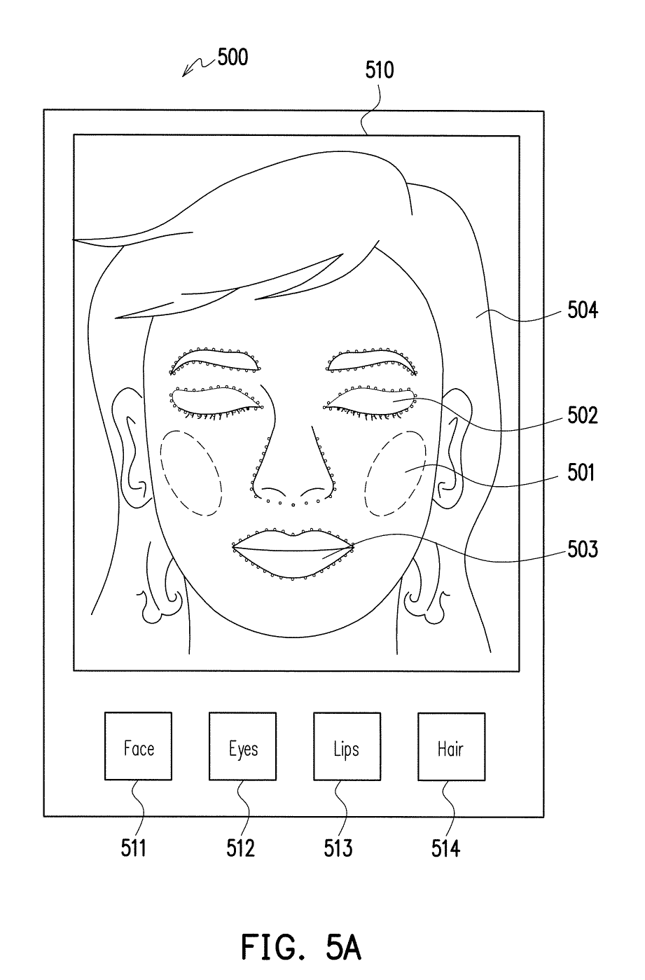

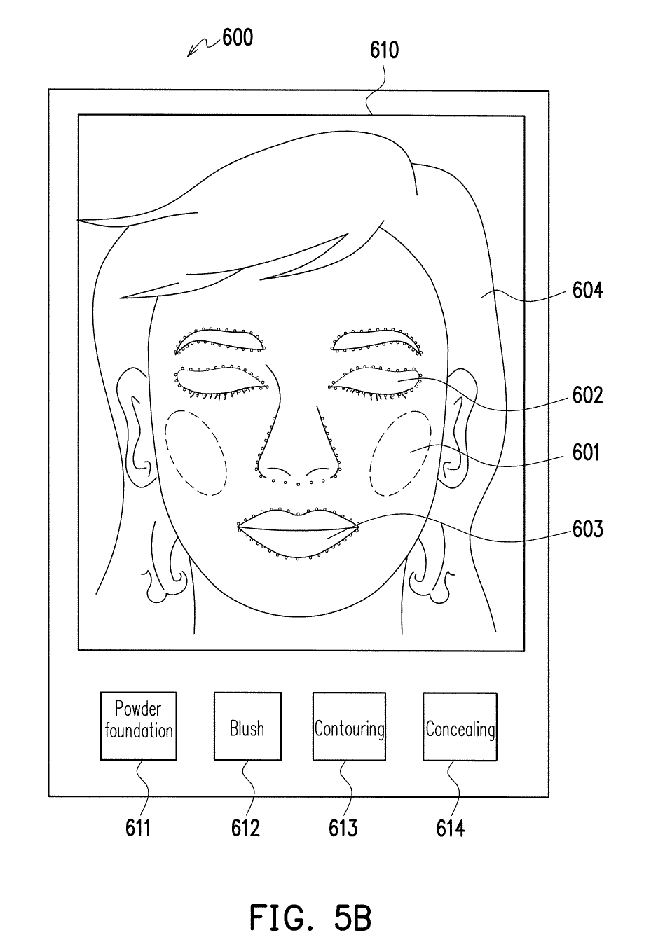

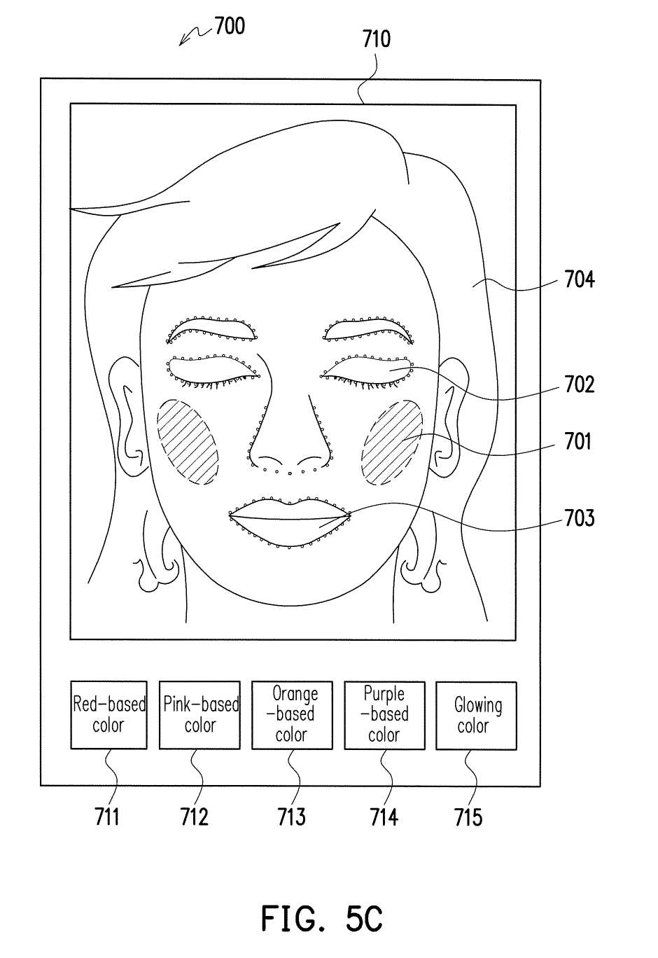

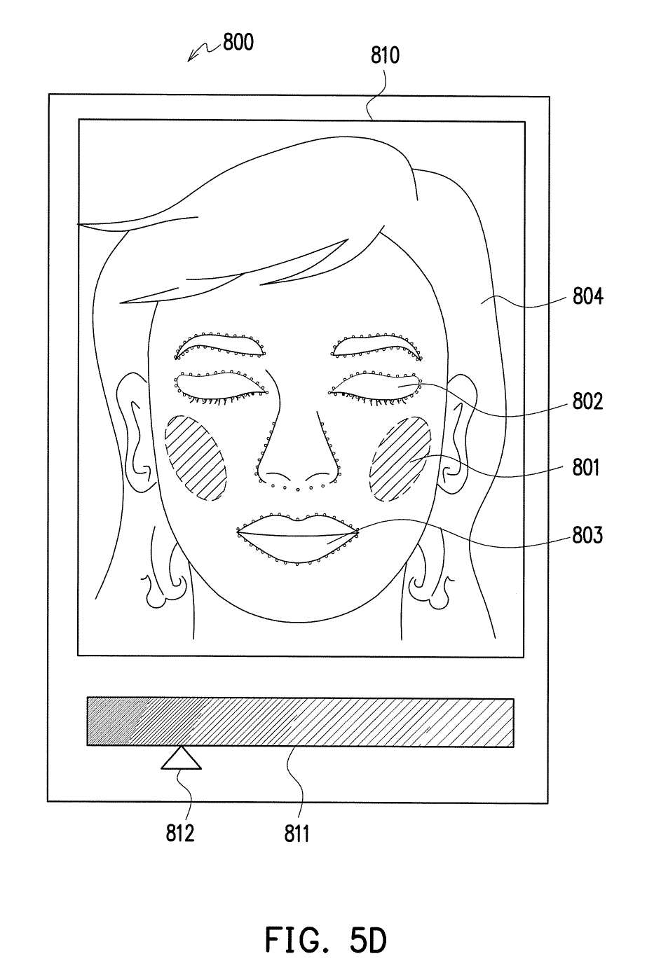

Referring to FIG. 4, FIG. 4 is a schematic view illustrating an analysis on a facial image according to the invention. It should be noted that, in the embodiment, the processor 110 may analyze respective features of a facial image 410 by performing an image processing operation, so as to set a plurality of makeup trial parts on the face. For example, the makeup trial parts may include at least one of a face block 401, an eye block 402, a lip block 403, a hair block 404, and an eyebrow block 405. However, the invention is not limited thereto. In the following, schematic views of respective selection frames, as shown in FIG. 5A to 5D, are described with reference to the respective steps of FIG. 3.

Referring to FIG. 5A, FIG. 5A is a schematic view illustrating a makeup trial part selecting frame according to an embodiment of the invention. At Step S330, the processor 110 displays a makeup trial part selecting frame 500 through the display 120. In addition, the makeup trial part selecting frame 500 includes a facial image 510 and icons 511 to 514. In the embodiments, the icons 511 to 514 may respectively represent face, eyes, lips, and hair. In addition, the icons 511 to 514 may respectively correspond to the face block 501, the eye block 502, the lip block 503, and the hair block 504 in the facial image 510. In other words, the person trying makeup may select the makeup trial part by clicking on one of the icons 511 to 514 in the makeup trial electing frame 500 shown on the display 120. Thus, in response to receiving an operation corresponding to the makeup trial part selecting frame 500, the processor 110 may display a selection frame of the next step through the display 120. However, the makeup trial parts represented by the icons 511 to 514 and the number of icons are only described herein for an illustrative purpose. The invention does not intend to impose a limitation on this regard.

Referring to FIG. 5B, FIG. 5B is a schematic view illustrating a makeup trial type selecting frame according to an embodiment of the invention. At Step S340, in response to receiving the operation corresponding to the makeup trial part selecting frame (as shown in FIG. 5A), the processor 110 displays a makeup trial type selecting frame 600 through the display 120. In addition, the makeup trial type selecting frame 600 includes a facial image 610 and icons 611 to 614. In the embodiment, the icons 611 to 614 respectively represent powder foundation, blush, contouring, and concealing. In addition, the icons 611 to 614 may respectively correspond to a face block 601, an eye block 602, a lip block 603, and a hair block 604 in the facial image 610. In other words, the person trying makeup may select the makeup to be applied on the makeup trial part by clicking on one of the icons 611 to 614 in the makeup trial type selecting frame 600 shown on the display 120. Thus, in response to receiving an operation corresponding to the makeup trial type selecting frame 600, the processor 110 may display a selection frame of the next step through the display 120. However, the makeup trial types represented by the icons 611 to 614 and the number of icons are only described herein for an illustrative purpose. The invention does not intend to impose a limitation on this regard.

Referring to FIG. 5C, FIG. 5C is a schematic view illustrating a makeup trial sub-type selecting frame according to an embodiment of the invention. At Step S350, in response to receiving the operation corresponding to the makeup trial type selecting frame (as shown in FIG. 5B), the processor 110 displays a makeup trial sub-type selecting frame 700 through the display 120. In addition, the makeup trial sub-type selecting frame 700 includes a facial image 710 and icons 711 to 715. In the embodiment, the icons 711 to 715 respectively represent a red-based color, a pink-based color, an orange-based color, a purple-based color, and a glowing color. In addition, the icons 711 to 715 may respectively correspond to a face block 701, an eye block 702, a lip block 703, and a hair block 704 in the facial image 710. In other words, the person trying makeup may select a color of the makeup applied to the makeup trial part by clicking on one of the icons 711 to 715 in the makeup trial sub-type selecting frame 700 shown on the display 120. Thus, in response to receiving an operation corresponding to the makeup trial sub-type selecting frame 700, the processor 110 may display a selection frame of the next step through the display 120. However, the makeup trial sub-types represented by the icons 711 to 715 and the number of icons are only described herein for an illustrative purpose. The invention does not intend to impose a limitation on this regard.

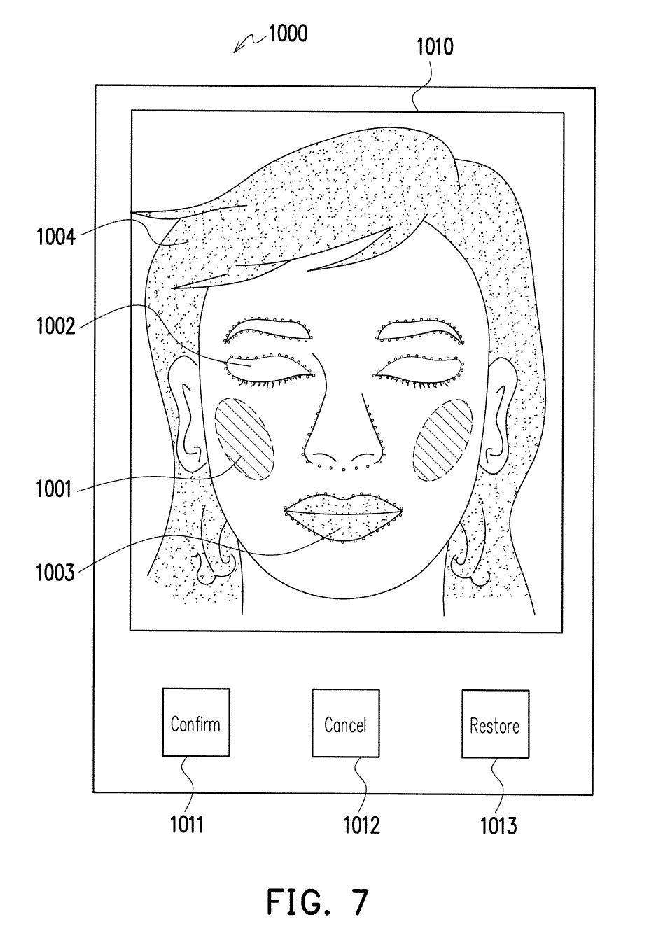

Then, at Step S360, the processor 110 edits the facial image 710 and displays a makeup trial result of the facial image in the makeup trial result frame. In addition, the makeup trial result frame and the makeup trial sub-type selecting frame 700 may be the same frame. In the face block 701 of the facial image 710, a result of the color of makeup selected by the person trying makeup may be directly displayed. Alternatively, in an embodiment, the processor 110 may also display the makeup trial result frame as shown in FIG. 7 through the display 120. In addition, at Step S370, the person trying makeup may determine whether to operate the electronic apparatus 100 to proceed to the next adjustment frame based on whether he/she is satisfied with the makeup trial result.

Referring to FIG. 5D, FIG. 5D is a schematic view illustrating a makeup trial adjustment frame according to an embodiment of the invention. At Step S380, in response to receiving the operation corresponding to the makeup trial type selecting frame (as shown in FIG. 5B), the processor 110 displays a makeup trial sub-type selecting frame 800 through the display 120. In addition, the makeup trial sub-type selecting frame 800 includes a facial image 810 and icons 811 and 812. In the embodiment, the icon 811 may be a color band indicating a shade of color, and the icon 812 may be an arrow sign indicating a current shade of color. The icons 811 and 812 may respectively correspond to a face block 801, an eye block 802, a lip block 803, and a hair block 804 in the facial image 810. In addition, a corresponding color is applied to the facial block 801 (blush). In other words, the person trying makeup may click on the icon 812 in the makeup trial sub-type selecting frame 800 shown on the display 120 and slide to choose the shade of color of the face block 801. However, the adjustment to the shade of color with the icons 811 and 812 are only described herein for an illustrative purpose, and the invention is not limited thereto.

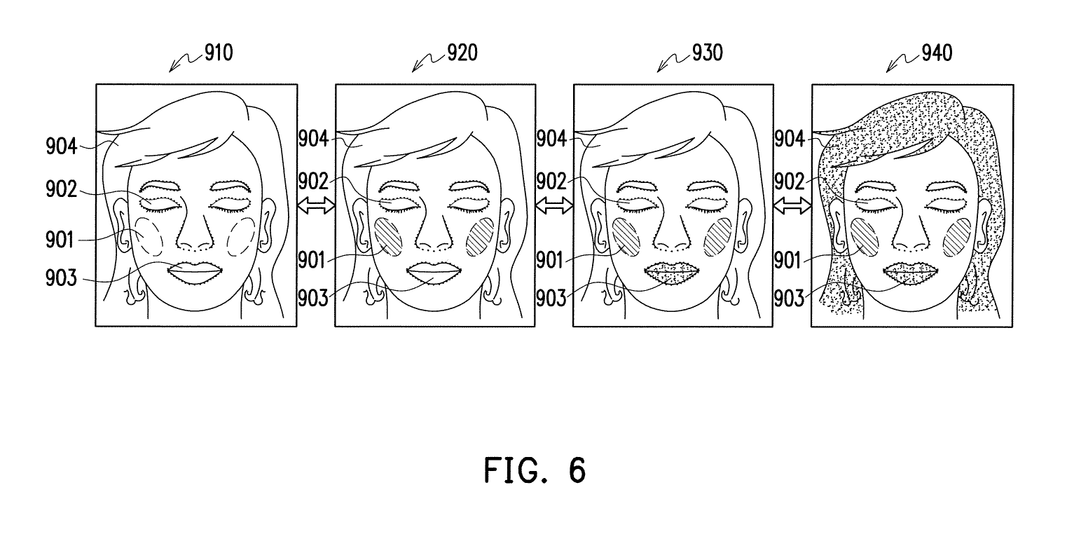

Back to Step S370, if the person trying makeup is satisfied with the makeup trial result, Step S320 may be repeated to determine whether to continue with makeup trial editing. In other words, the electronic apparatus 100 according to the embodiments of the invention is able to carry out makeup trial operations on a plurality of makeup trial parts of the same facial image. Referring to FIG. 6, FIG. 6 is a schematic view illustrating a plurality of makeup trial operations according to an embodiment of the invention. As shown in the figure, facial images 910 to 940 respectively represent makeup trial operations at different stages. In the embodiment, the processor 110 may sequentially edit the facial images 910 to 940 in response to the operations according to the embodiments of FIGS. 5A to 5D, and sequentially display editing results in the makeup trial result frame through the display 120. For example, the facial image 910 is an original image. The facial image 920 indicates that a face block 901 is edited. The facial image 930 indicates that the face block 901 and a lip block 903 are edited. The facial image 940 indicates that the face block 901, the lip block 904, and a hair block 904 are edited. However, a sequence of makeup trial operations shown in the facial images 910 to 940 is only described herein for an illustrative purpose, and the invention is not limited thereto.

In the embodiment, the processor 110 is able to record an editing sequence and an edited parameter of the facial images 901 to 904. In other words, the electronic apparatus 100 according to the embodiments of the invention is able to dynamically restore the editing results of the facial image through the editing sequence and the edited parameter of the facial images 901 to 904. For example, if the person trying makeup has a second thought on the makeup trial result of the hair block 904, he/she may dynamically restore to the facial images 901 to 903 to carry out makeup trial editing again.

Referring to FIG. 7, FIG. 7 is a schematic view illustrating a makeup trial result frame according to an embodiment of the invention. At Step S320, the processor 110 may display a makeup trial result frame 1000 through the display 120. The makeup trial result frame 1000 includes a facial image 1010 and icons 1011 to 1013. The facial image 1010 includes a face block 1001, an eye block 1002, a lip block 1003, and a hair block 1004. In the embodiments, the icons 1011 to 1013 may respectively represent confirm, cancel, and restore. In other words, the person trying makeup may click on one of the icons 1011 to 1013 in the makeup trial result frame 1000 to decide to store the makeup trial editing results, cancel the makeup trial editing results, or restore the makeup trial editing results.

In view of the foregoing, the electronic apparatus and the method for makeup trial information of the electronic apparatus according to the embodiments of the invention enable selection on different makeup trials through the operations of the person trying makeup in the makeup trial part selecting frame, the makeup trial type selecting frame, the makeup trial sub-type selecting frame, and the makeup trial adjustment frame. Accordingly, the facial image of the person trying makeup is edited by the processor of the electronic apparatus to generate different makeup trial results. In addition, as shown in the respective embodiments, the facial image is not specifically limited to the generally defined face but may also include hair or neck. In addition, the electronic apparatus according to the embodiments of the invention may further include the editing sequence and the edited parameter with respect to each facial image to offer a function of dynamic restoration. Accordingly, the person trying makeup is provided with quick, accurate, and convenient makeup trial information and functions through the display of the electronic apparatus.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for providing makeup trial information, adapted for an electronic apparatus having a display configured to display a facial image of a person trying makeup before or after editing, wherein the method comprises:
displaying a makeup trial part selecting frame through the display, wherein the makeup trial part selecting frame comprises the facial image;
displaying a makeup trial type selecting frame through the display in response to receiving a first operation corresponding to the makeup trial part selecting frame;
editing the facial image in response to receiving a second operation corresponding to the makeup trial type selecting frame; and
displaying a makeup trial result frame through the display, and recording an editing sequence and an edited parameter of the facial image, wherein the makeup trial result frame comprises the facial image after editing.

2. The method for providing makeup trial information as claimed in claim 1, wherein the electronic apparatus further comprises an image capturing device, and the method further comprises:
obtaining the facial image through the image capturing device.

3. The method for providing makeup trial information as claimed in claim 1, wherein the electronic apparatus further comprises a storage device, and the method further comprises:
accessing the storage device to obtain the facial image.

4. The method for providing makeup trial information as claimed in claim 1, wherein editing the facial image in response to receiving the second operation corresponding to the makeup trial type selecting frame comprises:
displaying a makeup trial sub-type selecting frame through the display in response to receiving the second operation corresponding to the makeup trial type selecting frame; and
editing the facial image in response to receiving a third operation corresponding to the makeup trial sub-type selecting frame.

5. The method for providing makeup trial information as claimed in claim 4, wherein editing the facial image in response to receiving the third operation corresponding to the makeup trial sub-type selecting frame comprises:
displaying a makeup trial adjustment frame through the display in response to receiving the third operation corresponding to the makeup trial sub-type selecting frame; and
adjusting a makeup trial result of the facial image in the makeup trial result frame in response to receiving a fourth operation corresponding to the makeup trial adjustment frame.

6. The method for providing makeup trial information as claimed in claim 1, further comprising:
storing the facial image after editing based on whether a fifth operation corresponding to the makeup trial result frame is received.

7. The method for providing makeup trial information as claimed in claim 1, further comprising:
sequentially editing the facial image and sequentially displaying a plurality of the facial images after editing in the makeup trial result frame through the display in response to a plurality of the first operations and a plurality of the second operations.

8. The method for providing makeup trial information as claimed in claim 7, further comprising:
dynamically restoring to one of the facial images after editing according to the editing sequence and the edited parameter in response to a sixth operation based on whether the sixth operation corresponding to the makeup trial result frame is received.

9. An electronic apparatus, comprising:
a display, configured to display a facial image of a person trying makeup before or after editing; and
a processor, coupled to the display, and configured to drive the display,
wherein the processor displays a makeup trial part selecting frame through the display, wherein the makeup trial part selecting frame comprises the facial image,
wherein the processor displays a makeup trial type selecting frame through the display in response to receiving a first operation corresponding to the makeup trial part selecting frame,
wherein the processor edits the facial image in response to receiving a second operation corresponding to the makeup trial type selecting frame, and
wherein the processor displays a makeup trial result frame through the display, and records an editing sequence and an edited parameter of the facial image, wherein the makeup trial result frame comprises the facial image after editing.

10. The electronic apparatus as claimed in claim 9, wherein the electronic apparatus further comprises an image capturing device, and the processor obtains the facial image through the image capturing device.

11. The electronic apparatus as claimed in claim 9, wherein the electronic apparatus further comprises a storage device, and the processor obtains the facial image by accessing the storage device.

12. The electronic apparatus as claimed in claim 9, wherein the processor displays a makeup trial sub-type selecting frame through the display in response to receiving the second operation corresponding to the makeup trial type selecting frame, and the processor edits the facial image in response to receiving a third operation corresponding to the makeup trial sub-type selecting frame.

13. The electronic apparatus as claimed in claim 12, wherein the processor displays a makeup trial adjustment frame through the display in response to receiving the third operation corresponding to the makeup trial sub-type selecting frame, and the processor adjusts a makeup trial result of the facial image in the makeup trial result frame in response to receiving a fourth operation corresponding to the makeup trial adjustment frame.

14. The electronic apparatus as claimed in claim 9, wherein the processor stores the facial image after editing based on whether a fifth operation corresponding to the makeup trial result frame is received.

15. The electronic apparatus as claimed in claim 9, wherein the processor sequentially edits the facial image and sequentially displays a plurality of the facial images after editing in the makeup trial result frame through the display in response to a plurality of the first operations and a plurality of the second operations.

16. The electronic apparatus as claimed in claim 15, wherein the processor dynamically restores to one of the facial images after editing according to the editing sequence and the edited parameter in response to a sixth operation based on whether the sixth operation corresponding to the makeup trial result frame is received.
